(19) United States
(12) Patent Application Publication
(10) Pub. No.: US 2014/0165329 A1
(43) Pub. Date: Jun. 19, 2014

(54) LINKAGE ARM OF A SWIVEL-DOOR-LEAF ACTUATOR

(71) Applicant: DORMA GMBH CO.KG, Ennepetal (DE)

(72) Inventor: Thomas Wildförster, Schwelm (DE)

(21) Appl. No.: 14/232,153

(22) PCT Filed: May 30, 2012
(86) PCT No.: PCT/EP2012/002283

§ 371 Date: Jan. 10, 2014

(30) Foreign Application Priority Data
Jul. 13, 2011 (DE) 10 2011 051 819.3
Dec. 23, 2011 (DE) 10 2011 056 961.8

(51) Int. Cl. E05F 1/00

(52) U.S. Cl. CPC E05F 1/00
USPC 16/71

(57) ABSTRACT

An arm, forming a linkage arm, includes: a first linkage arm part; and a second linkage arm part. The first linkage arm part is arranged with one end at a driven shaft of a swing leaf operator so as to be fixed with respect to rotation relative to the driven shaft, so that the swing leaf operator can swivel the first linkage arm part around a first end of the first linkage arm part, as a center point of a rotational axis of the first linkage arm part, the first linkage arm part being configured, at a second end of the first linkage arm part, to be arranged at a first end of the second linkage arm part, so as to be fixed with respect to rotation relative to the second linkage arm part.

### CROSS-REFERENCE TO RELATED APPLICATIONS

This is a U.S. national stage of application No. PCT/EP2012/002283, filed on 30 May 2012, which claims priority to the German Application Nos. 10 2011 051 819.3, filed 13 Jul. 2011, and 10 2011 056 961.8 filed 23 Dec. 2011, the content of all three incorporated herein by reference.

### BACKGROUND OF THE INVENTION

1. Field of the Invention

The present invention is directed to a linkage arm for a swing leaf operator, i.e., for a device which is adapted to open and/or close a swivel leaf with the intermediary of a linkage with this linkage arm.

2. Related Art

As is well known, there are three types of linkage: standard linkage, parallel linkage and sliding rail linkage.

In the first two types of linkage, two linkage arms with ends facing one another are articulately arranged at one another or connected to one another. The free end of one of the linkage arms is arranged at the driven shaft of the associated swing leaf operator, for example, in the form of a door closer or swing door drive, so as to be fixed with respect to rotation relative to it. Depending on whether the swing leaf operator is mounted at the swing leaf itself (leaf panel mounting) or at a part, such as a door lintel (lintel mounting) that is stationary with respect to the entire swing leaf installation, the free end of the other linkage arm is articulately arranged by a fastening part or a fastening stop correspondingly at a part that is stationary with respect to the swing leaf installation or at the swing leaf, respectively. Therefore, as is well known, the swing leaf operator is able to transform a rotation of its driven shaft into a swiveling of the above-mentioned one linkage arm and transmit it to the other linkage arm by its articulate connection to this other linkage arm. Owing to the articulation of the other linkage arm, the swing leaf operator can open and/or close the connected swing leaf.

In the sliding rail linkage, there is only one (sliding) linkage arm, which is arranged with one end at the driven shaft of the respective swing leaf operator. Articulately arranged at its other, free end is a sliding piece, which is received so as to be translationally guided in a guide rail. Again depending on whether the swing leaf operator is mounted at the swing leaf or at a part which is stationary with respect to the entire installation, the guide rail is correspondingly fastened to a part that is stationary with respect to the swing leaf installation or to the swing leaf Accordingly, the swing leaf operator is able to transform a rotation of its driven shaft into a swiveling of the sliding rail linkage arm and into a movement of the sliding piece in the guide rail by its articulate connection to the sliding piece guided in the guide rail. Owing to the fastening of the guide rail, the swing leaf operator can open and/or close the connected swing leaf.

As a rule, swing leaves of this kind are rabbeted. As is well known, in the closed position they are positioned with their rabbet on a leaf frame or leaf lintel, which surrounds this leaf and which is stationary with respect to the swing leaf installation.

However, it may be that the swing leaf does not have a rabbet of this kind but rather is constructed so as to be flush, i.e., without a rabbet. In this case, the leaf is completely surrounded by the frame in the closed position. If the swing leaf is substantially narrower than the leaf frame or leaf lintel, there will be a depth mismatch or offset with respect to the frame viewed in the closing direction; the swing leaf is set deeper in the frame or lintel with respect to the swing leaf installation in the closed position viewed in the direction of entry or opposite thereto.

A problem can also occur with rabbeted swing leaves when the swing leaf operator is intended to open the connected lintel-mounted swing leaf by pushing, i.e., when it is mounted on the opposite hinge side). In this case also, there is an offset between the frame or lintel and the swing leaf which is at a greater depth in the opening direction of the swing leaf.

In the latter two cases the swing leaf operator should generate a torque curve at the connected swing leaf and, accordingly, a driving force curve against the swing leaf corresponding to the curve of the first-mentioned swing leaf installation, i.e., without depth offset. The driving force is the force that can be transmitted by the swing leaf operator to the driven shaft and on to the swing leaf in the respective direction in which the swing leaf operator is to move the swing leaf. Typically linear linkage arms cannot be used for this purpose because the swing leaf operator would then be incapable of realizing a torque curve as in the first-mentioned swing leaf installation.

In addition, for safety reasons, the driven shaft of a swing leaf operator of this kind and the linkage arm, which is arranged at the latter so as to be fixed with respect to rotation relative to it, engage with one another by positive engagement so that these two parts cannot be arranged in a desired manner relative to one another in order to overcome this problem.

To remedy this problem, one of the linkage arms is formed essentially of two parts for standard and parallel linkages. This linkage arm has two rod parts, one being screwed into the other. Because of this, it is possible to vary the relative position of the rod parts with respect to one another and, therefore, the length of the entire linkage arm and to adapt to on-site conditions. The constructional expense and the unattractive appearance of outwardly visible threads of the one rod part screwed into the other rod part are disadvantageous.

Linkage arms which are formed in an angled rather than in a linear manner viewed along the axis of rotation of the driven shaft have been developed for sliding rail linkages. The driven shaft and linkage arm can only be fastened to one another in one orientation relative to one another; i.e., a bent linkage arm of this kind is only suitable for one orientation of the bend of the linkage arm in relation to the swing leaf operator.

### SUMMARY OF THE INVENTION

It is an object of the invention to overcome the above-mentioned disadvantages and problems.

According to one aspect of the invention, an arm is provided which forms a linkage arm of a standard linkage, parallel linkage or sliding rail linkage. In the case of standard linkage and parallel linkage, this arm has two linkage arms which are operatively connected to one another articulately in a known manner. The linkage arm which is operatively connected to the driven shaft so as to be fixed with respect to rotation relative to it or arranged at this driven shaft so as to be fixed with respect to rotation relative to it is formed by the arm according to the invention. The arm has a first linkage arm part and a second linkage arm part. The first linkage arm part is configured to be arranged with one end at a driven shaft of a swing leaf operator in a known manner so as to be fixed with respect to rotation relative to it. Accordingly, the swing leaf operator is able to swivel or rotate the first linkage arm part, likewise in a known manner, around its one end as a center point of a so-defined rotational axis of the first linkage arm part. The first linkage arm part is further configured to be arranged with its other end at an end of the second linkage arm part so as to be fixed with respect to rotation relative to it or so as to be connected to it. The other end of the second linkage arm part is configured, likewise in a known manner, to be articulately connected in such a way to a part which is arranged so as to be swivelable with respect to the swing leaf operator that the swing leaf operator is able to open and/or close a connected swing leaf via its driven shaft and the standard linkage, parallel linkage or sliding rail linkage connected thereto. Here, “connected” means that either the linkage is secured to the swivelably arranged part or the swing leaf operator is secured to the swing leaf and, consequently, that the swing leaf operator or linkage is secured to the swivelably arranged part at a part of the overall leaf installation, which is stationary with respect to this installation. Further, both linkage arm parts are configured, viewed in a direction along the rotational axis of the first linkage arm part to, be arranged at one another so as to be fixed with respect to relative rotation such that, in a first mounting condition, the two linkage arm parts form a reflex angle at one side viewed in direction along the rotational axis of the first linkage arm part. They are further configured in a second mounting condition, again in direction along the rotational axis of the first linkage arm part, to form a reflex angle at another side opposed to the aforementioned side; i.e., the linkage arm parts can be mounted relative to one another in two positions with respect to the swing leaf operator, wherein the bends of the arm according to the invention formed by the linkage arm parts, which bends are formed by the respective reflex angle, are directed in mutually opposed directions depending on how they are secured to one another. In this way, the first linkage arm part can always be secured to the driven shaft of the swing leaf operator in the same manner. Further, the same torques are accordingly generated at the linkage and swing leaf by the connected swing leaf operator in both mounting conditions, which results in identical or very similar swing leaf drive forces. The bends of the arm with respect to the swing leaf operator, which are directed in different directions relative to one another, allow one and the same swing leaf operator to be used, for example, on the hinge side or on the opposite hinge side, specifically on a DIN left-handed swing leaf as well as on an identically constructed DIN right-handed swing leaf without requiring additional parts or substituting other parts and without modifying the torque curve present at the swing leaf or generated thereby.

When changing from the hinge side to the opposite hinge side, or vice versa, it may be necessary to change the linkage arm, which is arranged at the driven shaft so as to be fixed with respect to rotation relative to it, but to change only this linkage arm. No other changes are necessary.

In one aspect, each of the linkage arm parts preferably has one or more fasteners formed in such a way that in the first mounting condition the second linkage arm part, viewed along the rotational axis of the first linkage arm part, is arranged so as to be rotated by a predetermined angle with respect to the second mounting condition. This angle defines the two bend positions of the linkage arm parts relative to one another.

Additionally or alternatively, the fasteners are so constructed that in the first mounting condition the second linkage arm part, viewed along the longitudinal extension of the first linkage arm part, is arranged at 180° with respect to the second mounting condition. In other words, in both cases, when changing, for example, from a DIN left-handed door to a DIN right-handed door, only the second linkage arm part need be rotated by 180° and the “new” arm formed in this way is ready to use. The first linkage arm part need not even be removed from the swing leaf operator, which keeps mounting simple. Further, this allows a very simple initial mounting because it is only necessary to pay attention to the orientation of the linkage arm parts relative to one another.

In this regard, the first linkage arm part and/or the second linkage arm part can each have a fastening device which is formed symmetrically viewed along the longitudinal extension of the first linkage arm part or second linkage arm part. This makes it possible to reduce the fastening device to component parts all of which or parts of which are used in both mounting conditions. This facilitates the constructional makeup of the arm according to the invention.

These fastening devices can comprise fastening openings. These fastening openings particularly facilitate mounting, for example, when the linkage arm parts are fastened to one another by screws.

At the same time, the arrangement of the fastening openings preferably defines the reflex angle between the linkage arm parts. This serves to prevent or reduce possible mounting errors, i.e., it serves to further simplify mounting.

In another aspect, at least some of the fastening openings preferably extend parallel to the above-mentioned rotational axis of the first linkage arm part. This allows the second linkage arm part to be mounted on the first linkage arm part even when the swing leaf operator is already arranged at the swing leaf installation. In other words, the linkage need not be mounted beforehand and then fixed in some way and lifted together with the swing leaf operator in order that the latter can be arranged at all.

In another aspect, at least some of the fastening openings can be provided with an inner thread. This has the advantage that the fastening of the linkage arm parts to one another is carried out simply by tightening a respective screw. Other parts such as nuts, washers and the like can be dispensed with. This makes it possible to fasten the linkage arm parts to one another in a simple manner even for overhead mounting.

Additionally or alternatively, at least some of these fastening openings are formed so as to pass through completely. Further, they are formed in such a way that a fastening element corresponding to the respective fastening opening can be inserted into the respective fastening opening from both sides thereof. In conjunction with the symmetry mentioned above, this allows the respective fasteners to be inserted always from one side, for example, the bottom side, when the swing leaf operator is mounted so that the manner of fastening the linkage arm parts to one another never varies in spite of differing orientation of the above-mentioned bend. This likewise serves to prevent mounting errors.

In another aspect, each of the above-mentioned arms can have adjusting devices for adjusting the reflex angle between the two linkage arm parts. This allows the first linkage arm part to be arranged at the driven shaft in the customary manner while nevertheless allowing the entire arm to be adapted to on-site conditions.

In a preferable manner, these adjusting devices include a catch mechanism which is formed on at least one of the linkage arm parts. Although this limits the choice of relative position of the linkage arm parts with respect to one another, it reduces mounting errors.

According to another aspect of the present invention, a swing leaf operator has a driven shaft, which emerges from the rest of the swing leaf operator at at least one end. It further has an actuating mechanism. This actuating mechanism, for example, in the form of a motor transmission arrangement or a closer spring mechanism, is operatively coupled to the driven shaft in a known manner so as to rotate the latter in at least one rotational direction or driving direction. The swing leaf operator further includes a standard linkage, parallel linkage or sliding rail linkage, which is provided, according to the invention, with one of the aforementioned arms. The driven shaft has a fastening portion at the at least one emerging end. The fastening portion is configured so as to be connected to the aforementioned one end of the first linkage arm part so as to be fixed with respect to rotation relative to it. In the case of a standard linkage or parallel linkage, the other end of what is now the second linkage arm part is articulately connected, likewise in a known manner, to a fastening stop as above-mentioned part that is swivelably arranged with respect to the swing leaf operator. In case of a sliding rail linkage, this other end of the second linkage arm part is articulately connected also in a known manner to a sliding piece as above-mentioned part which is swivelably arranged with respect to the swing leaf operator, this sliding piece being translationally guided in a sliding rail of the swing leaf operator.

Finally, according to an aspect of the invention a swing leaf installation has a swing leaf and the swing leaf operator described above. The swing leaf operator is arranged in a known manner at the swing leaf in case of leaf panel mounting or at a part which is stationary with respect to the entire swing leaf installation in case of lintel mounting. In the simplest case, this part is a leaf lintel or a crossbeam of a frame surrounding the leaf. Accordingly, the aforementioned part, which is arranged so as to be swivelable with respect to the swing leaf operator, is arranged, likewise in a known manner, at the part that is stationary with respect to the entire swing leaf installation in case of leaf panel mounting or at the swing leaf in case of lintel mounting. In other words, aside from the basic duplexity of the arm, the arrangement does not otherwise change. Accordingly, very little changes for the person performing the mounting.

### BRIEF DESCRIPTION OF THE DRAWINGS

Further features and advantages of the invention are indicated in the following description of preferred embodiments. In the drawings:

FIG. 1 shows a section of a swing door installation;

FIGS. 2A and 2B show a sliding rail linkage arm according to a first embodiment of the invention in two mounting conditions;

FIGS. 3A to 3C are exploded views of the sliding rail linkage arm in the mounting condition shown in FIG. 2A;

FIGS. 4A to 4C show a sliding rail linkage arm according to a second embodiment of the invention analogous to the mounting condition shown in FIG. 2A;

FIGS. 5A and 5B show a sliding rail linkage arm according to a third embodiment of the invention analogous to the mounting condition shown in FIG. 2A;

FIG. 6 shows a sliding rail linkage arm according to a fourth embodiment of the invention analogous to the mounting condition shown in FIG. 2A;

FIG. 7 shows a modified linkage arm part;

FIG. 8 shows a coupling between a linkage arm part and a driven shaft of a swing leaf operator; and

FIGS. 9A and 9B show two views of another swing leaf installation.

### DETAILED DESCRIPTION OF THE PRESENTLY PREFERRED EMBODIMENTS

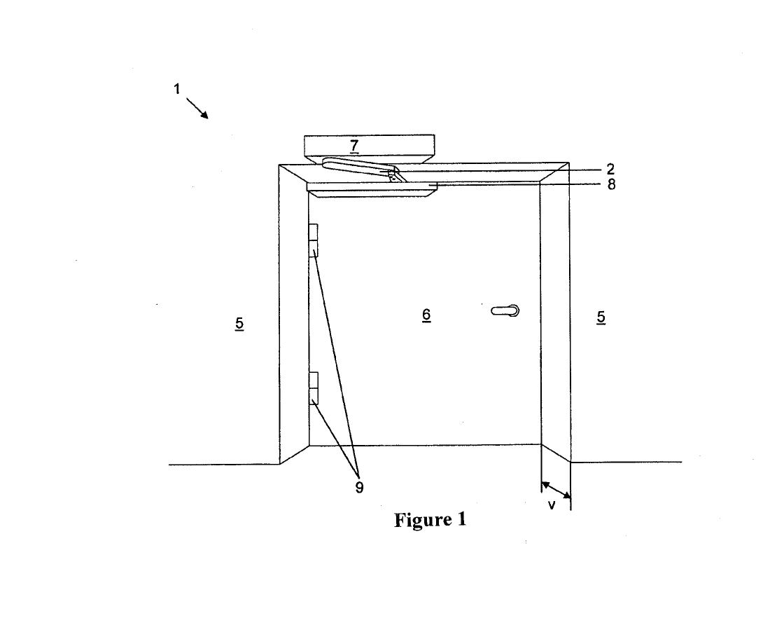

FIG. 1 shows an exemplary swing leaf installation 1 formed as a door installation. It includes a swing leaf 6, which is formed as a swing door leaf and which is arranged in an opening, not designated, of a wall 5 and closes this opening in the depicted closed position. The leaf 6 is hung in a known manner, in this case by two door hinges 9 arranged on the left-hand side.

Arranged above the leaf 6 is a swing leaf operator 7, which is constructed in a known manner, in this case in the form of a door closer or swing door drive. It is secured, for example, to the wall 5 above the leaf 6.

An arm 2 (described below) of a linkage in the exemplary form of a sliding linkage is arranged below the swing leaf operator 7. The arm 2 is operatively connected, likewise in a known manner, by its left-hand end in this case to one end of a driven shaft 30, not visible here, emerging at least in direction of the leaf 6 such that the arm 2 is fixed with respect to rotation relative to the driven shaft 30 and is secured to the latter.

The arm 2 forms a sliding arm, and a sliding piece, not visible, is articulately arranged, likewise in a known manner, at the end of the arm 2, in this case the right-hand end, and is received in a sliding rail 8 so as to be guided translationally, in this case from right to left. The sliding rail 8 is arranged at the leaf 6. As can be seen, the leaf 6 is offset somewhat to the rear in relation to the wall 5 surrounding it; that is, it has a depth offset v, in this case with respect to the front side of the wall 5.

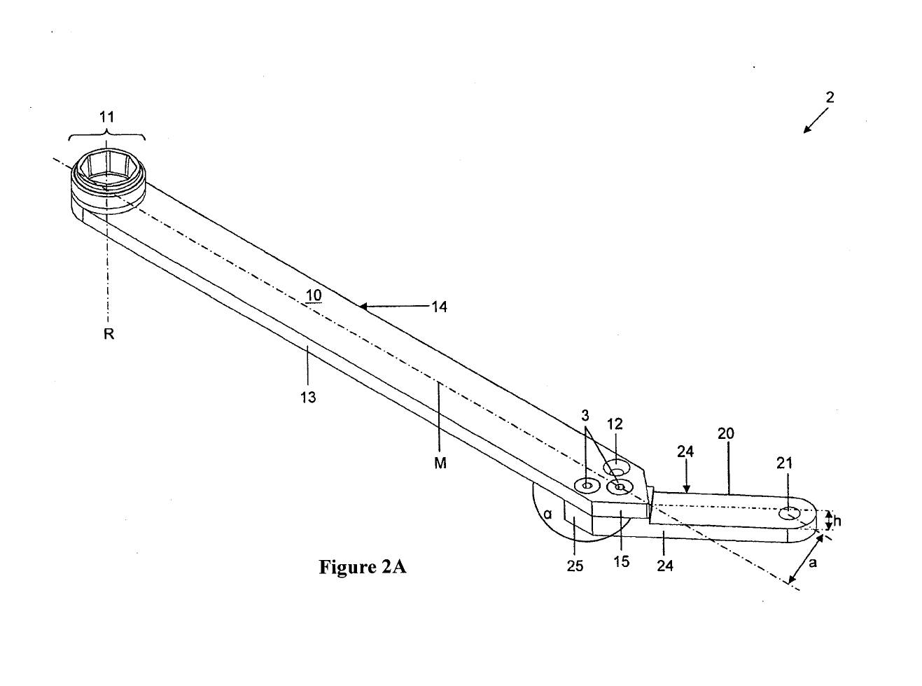

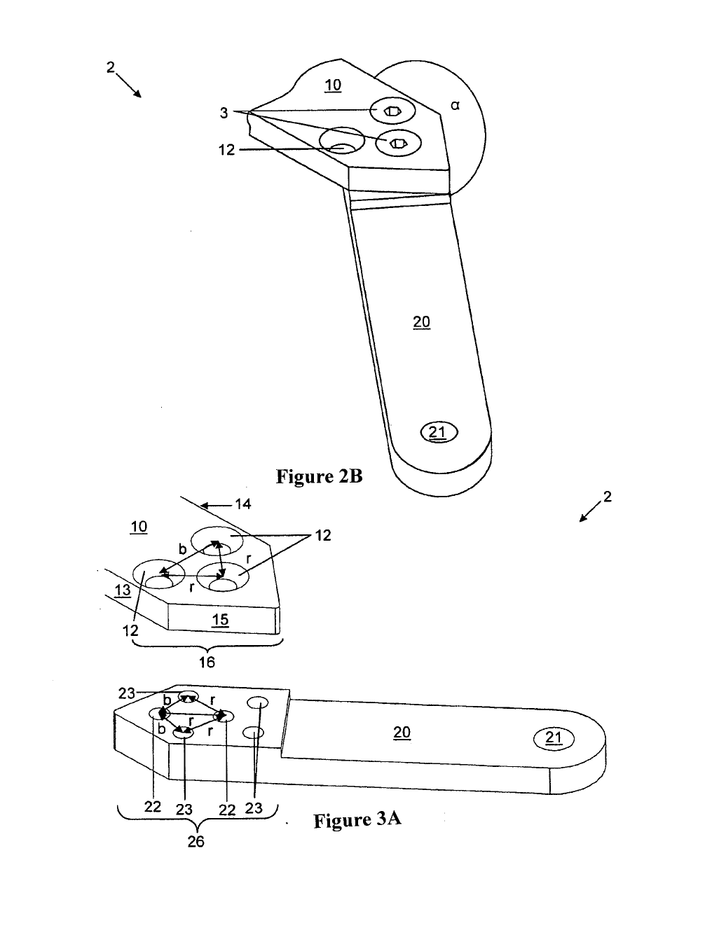

FIG. 2A shows the arm 2 of FIG. 1 in more detail and in a first mounting condition. As can be seen, the arm 2 is substantially formed of two parts. It includes two linkage arm parts 10, 20. The two linkage arm parts 10, 20 are arranged at one another so as to be fixed with respect to rotation relative to one another by two screws 3, 3. The arm 2 accordingly forms a type of bent sliding linkage arm.

Arm part 10 is provided with a fastening portion 11 at its free end, in this case the left-hand end, which fastening portion 11 is in the form of an inner-octagon-shaped fastening opening in this instance. This fastening portion 11 is arranged in a positively engaging manner on a proximal end of a driven shaft 30, not shown here, of the swing leaf operator 7 shown in FIG. 1 and is fixed thereto, for example, by a screw. Accordingly, there is defined here a rotational axis R around which arm part 10 is swiveled or rotated when the driven shaft 30 is rotated. The rotational axis R extends vertically in FIG. 2A.

The two arm parts 10, 20 form a reflex angle α with respect to their surfaces 13, 24, which face forward in this instance. This reflex angle α is preferably between 180° and 270° but can also be greater than or equal to 270° depending upon use. The arm 2 is bent as a result of the reflex angle α. In the mounting condition shown here, the bend extends toward the right-hand side in FIG. 2A proceeding from linkage arm part 10. The free end of arm part 20 comprises a fastening portion, in this case in the form of a fastening opening 21 which serves in a known manner for the articulated arrangement of the sliding piece, not shown; i.e., this fastening portion can have any shape for accommodating a sliding piece in an articulated manner.

Viewed in the direction of the longitudinal extension of the arm part 10, the fastening opening 21 has a distance a from a center line M of the arm part 10 extending in this direction, which distance a corresponds to the aforementioned depth offset v. This means that the distance dimension a is selected in such a way as to ensure that the swing leaf operator 7 generates a torque curve at the connected leaf 6 corresponding to the torque curve that would be generated if the swing leaf operator 7 were operatively connected to a conventional, linearly constructed sliding arm and the swing leaf installation 1 had no depth offset v. The distance dimension a is referenced by way of example to a reference line extending perpendicular to center line M.

The bend additionally has the effect that when the depth offset v is present the swing leaf operator 7 can open the connected leaf 6 as far as it could be opened if the depth offset v were not present.

The arm parts 10, 20 can be formed in such a way that mutually corresponding pairs of surfaces 13, 25 and 15, 24, respectively, of arm parts 10, 20, facing in the direction of the observer in this instance, line up flush with one another.

If the leaf 6 shown in FIG. 1 were provided with door hinges 9 on the right-hand side, the entire linkage arm 2 would actually have to be rotated such that its fastening portion 11 would be arranged on the right-hand side of arm part 10 and the arm part 20 would be arranged on the left-hand side of arm part 10 with reference to FIGS. 2A and 2B. In any case, as can be seen, the fastening portion 11 projects from the rest of arm part 10 in direction of the driven shaft 30. If the arm 2 were formed in one part, it would have to be rotated in such a way that its fastening portion 11 extended from the arm part 10 in direction away from the driven shaft 30. This would make it impossible, or at least more difficult, to connect the fastening portion 11. The biggest problem would be that there would no longer be any space between arm 2 and driven shaft 30 or swing leaf operator 7 in which the arm 2 could be moved freely past the rest of the swing leaf operator 7.

Therefore, it is provided within the framework of the invention to secure arm part 20 to arm part 10 in such a way that the pairs of surfaces 14, 25 and 15, 24, which in this instance face toward the back, line up flush with one another, i.e., with reference to FIG. 2A, the bend of arm part 10 extends toward the front and not toward the right-hand side.

This second mounting condition is shown in FIG. 2B. As is clearly shown, the screw 3 on the left-hand side with reference to FIG. 2A is inserted into the free, rear fastening opening 12 in FIG. 2A. The significance of the relocation of this screw 3 in arm part 10 will be explained more fully later on. Further, it can be seen that arm parts 10, 20 now form a reflex angle α at the opposite side with reference to FIG. 2A, i.e., the bend in the arm 2 formed in this way would basically extend downward in FIG. 2A.

As can be seen, the surfaces, not designated, of arm parts 10, 20 facing upward, i.e., in direction of the swing leaf operator 7, do not line up flush with one another but, rather, have an offset h relative to one another in the form of a vertical offset. The surface of arm part 10 accordingly lies closer to the swing leaf operator 7 than arm part 20. This makes it possible to arrange the sliding piece in such a way that it line ups flush with this surface of the arm part 10 or even ends somewhat deeper in FIG. 2A, i.e., also has a vertical offset with respect to this surface of the arm part 10.

This allows use in doors in which the swing leaf operator 7 is arranged, for example, at a door lintel whose side facing the associated door leaf 6 is at a distance such that a conventional sliding rail linkage arm with sliding piece could not be moved past the door lintel. Therefore, vertical compensation is possible with respect to the mounting positions of swing leaf operator 7 and the leaf 6 to be moved by the latter.

When mounting, it need only be ensured in extreme cases that arm part 10 can be freely moved past the lintel; arm part 20 can do this in any case.

Further, the bent shape of arm 2 makes it possible to use arm 2 in automatically closing swinging doors.

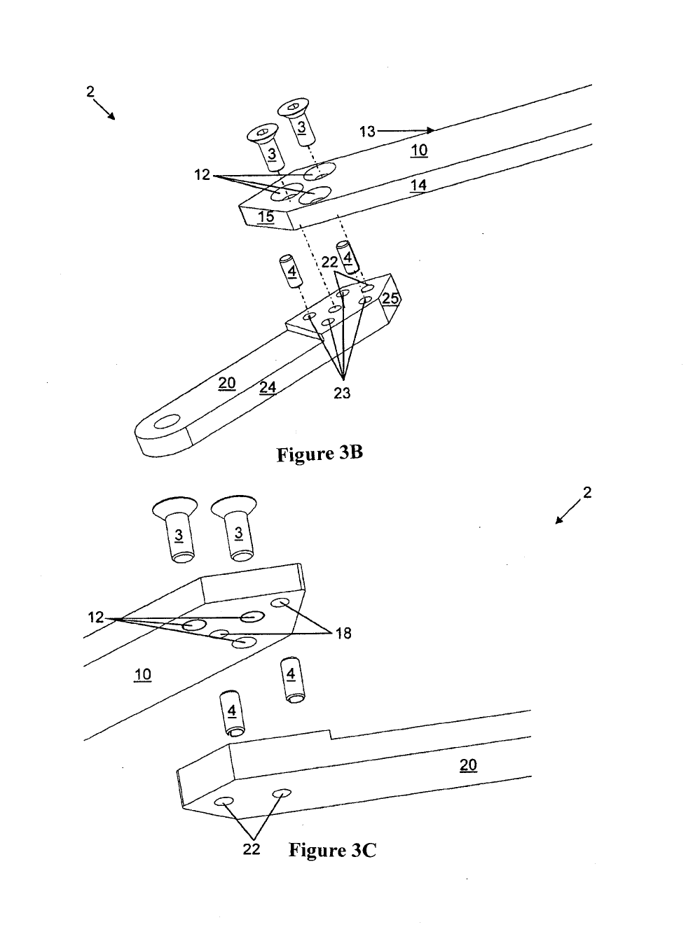

FIGS. 3A to 6 show arm 2 in the first mounting condition.

FIG. 3A is an exploded view of arm 2 of FIG. 2A without screws 3. As can be seen, arm part 10 has three fastening openings 12, which are formed as countersunk holes, by way of example. Referring to FIG. 2A, the screws 3 shown therein are accordingly inserted into the bottom two fastening openings 12 in FIG. 3A, whereas they are inserted into the two right-hand fastening openings 12 referring to FIG. 2B.

Arm part 20 comprises fastening openings 22 corresponding to fastening openings 12 of arm part 10, the screws 3 being inserted and screwed into these fastening openings 22 in both mounting conditions. In other words, the two respective associated fastening openings 12 are used depending on the orientation of arm parts 10, 20 with respect to one another: either the bottom two fastening openings 12 referring to FIG. 3A or the two fastening openings 12 positioned one above the other on the right-hand side. Therefore, there are two well-defined fastening positions of arm parts 10, 20 with respect to one another, or two mounting conditions of the arm 2, which allows for a very simple mounting with little propensity for error.

FIG. 3B and FIG. 3C show the arm 2 of FIG. 2A in an exploded view from the top and from the bottom, respectively, referring to FIG. 2A.

As can be seen, screws 3 are inserted through the associated fastening openings 12 and screwed to and into the associated fastening openings 22 insofar as the latter have inner threads. Further, two pins 4 are shown, which are inserted into corresponding openings 18, 23 of arm parts 10, 20 and accordingly fix the relative position of arm parts 10 with respect to one another beforehand. The insertion openings 18, 23 are, for example, not formed so as to pass through in a continuous manner, although this would be possible. The dash-dot lines show the openings 12, 22; 18, 23 of the arm parts 10, 20 into which the respective part 3, 4 is to be inserted or screwed.

As was described above, if the relative position of arm parts 10, 20 with respect to one another is to be changed, pins 4 would be inserted in the insertion openings 23 which are not provided with a dash-dot line in FIG. 3B.

As is indicated in FIG. 3A, the distance r of the center point of the fastening opening 22 on the right-hand side referring to FIG. 3A from the center point of the fastening opening 22 on the left-hand side in FIG. 3A and also from the center points of the fastening openings 23 arranged between these two fastening openings 22, 22 can all be identical. This also applies to the distances r between the center point of the fastening opening 12 at bottom right in FIG. 3A with respect to the center points of the other two fastening openings 12 of arm part 10. The center point of the fastening opening 22 on the left-hand side has a distance b from the center points of the directly adjacent fastening openings 23 in each instance. This is also true of the distance b between the center points of fastening openings 12 at bottom left and top right in FIG. 3A. In this case, these directly adjacent fastening openings 23 are also suitably formed such that a respective screw 3 can be screwed in or screwed through. In this way, it is also possible to align arm parts 10, 20 parallel to one another so that taken together they form a linear linkage arm 2. Therefore, there are three degrees of freedom of the arrangement of arm parts 10, 20 relative to one another or, expressed in a different way, three mounting conditions of the arm 2. In all of the relative configurations of the arm parts 10, 20, three screws 3 can be used in each instance. Thus, arm 2 can also be used in swing leaf installations without an offset v and is thus universally usable.

Pins 4 can also be dispensed with in this case.

All of the fastening openings 12 and 22, 23, respectively, are formed in the region of the ends 16, 26 of the arm parts 10, 20 facing one another.

The openings 12; 22, 23 are preferably formed in such a way that they are arranged or constructed symmetrically in longitudinal extension of the respective associated arm part 10, 20.

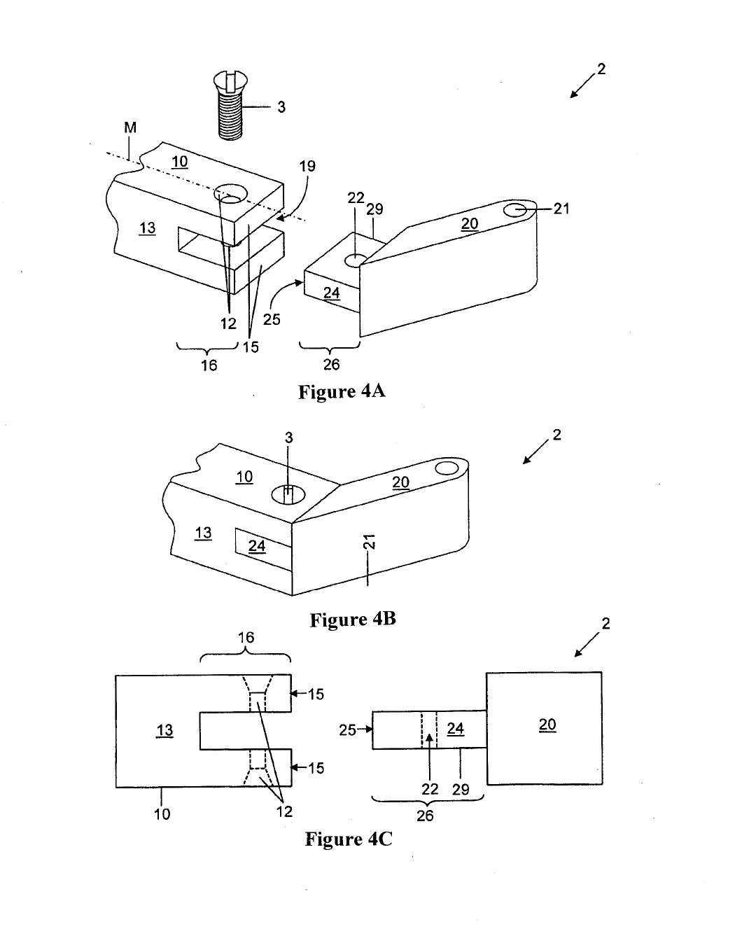

FIGS. 4A-4C show the arm parts 10, 20 of a sliding rail linkage arm 2 according to a second embodiment of the invention and in the region of their ends 16, 26, which face one another.

Arm part 10 has a centrally arranged, groove-like recess 19 at its end 16. Arm part 20 has a projection 29 corresponding to the groove-like recess 19 and is preferably shaped so as to complement recess 19, while forming an end 26.

In the illustrated example, recess 19 and projection 29 are shaped in such a way that after projection 29 is inserted into recess 19 the arm parts 10, 20 are arranged so as to be fixed with respect to rotation relative to one another. This is carried out by positioning surfaces 15, 25 against one another. In so doing, the fastening openings 12, 12, 22 are aligned in the first mounting condition shown in FIGS. 4A to 4C as well as in the aforementioned second mounting condition in which the arm part 10 or 20 is arranged so as to be rotated by 180° around the center line M. In other words, the center line M intersects fastening openings 12, 12, 22.

Of course, recess 19 and projection 29 can also be arranged at the other respective arm part 20 or 10.

The fastening openings 12, 12 are preferably formed as countersunk holes at their ends remote of one another. In this way, screw 3 can be inserted from the bottom as well as from the top referring to FIG. 4.

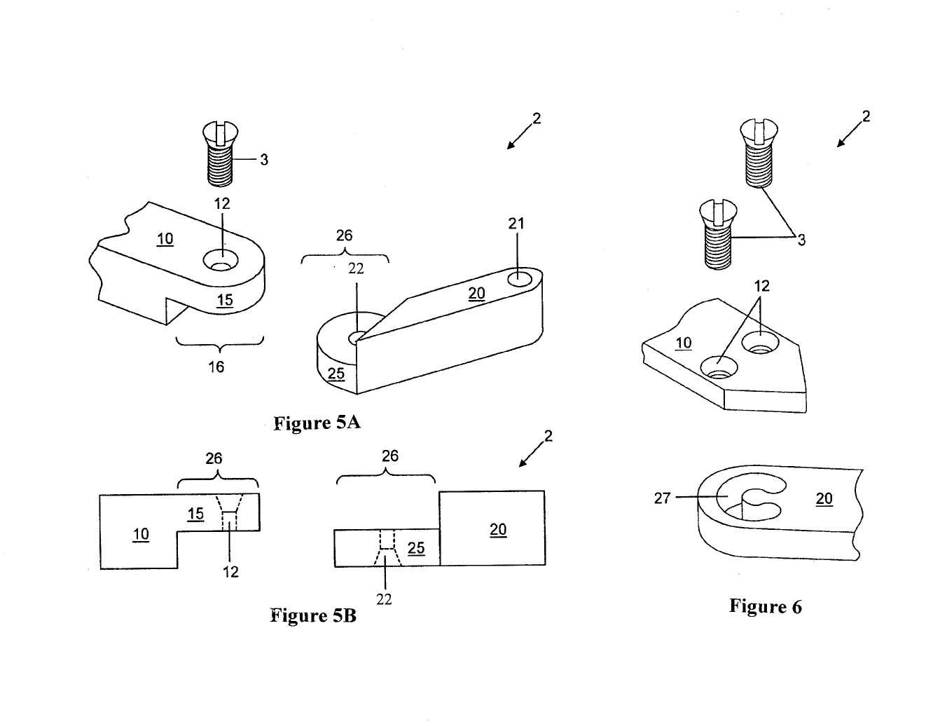

FIGS. 5A and 5B show arm parts 10, 20 of a sliding rail linkage arm 2 according to a third embodiment form of the invention, likewise in the region of their ends 16, 26 facing one another.

The two ends 16, 26 are L-shaped such that arm parts 10, 20 line up substantially flush with one another at the outer sides in the mounted state. End 16 has a corner-like recess facing in the direction of arm part 20. End 26 is semicircular in the direction of arm part 10 and accordingly allows arm parts 10, 20 to be pivoted relative to one another. Accordingly, bends can be realized in different configurations, enabling adaptation on site.

In this case, by way of example, there is only one fastening opening 12, 22. However, a plurality of fastening openings 12, 22 can also be provided to fix the relative position of arm parts 10, 20 with respect to one another and accordingly to realize the respective mounting condition.

FIG. 6 is an exploded view showing the arm parts 10, 20 of a sliding rail linkage arm 2 according to a fourth embodiment of the invention, likewise in the region of their ends 16, 26 facing one another, not shown.

Instead of fastening opening(s) 22, arm part 20 preferably has an elongated hole 27 following a circular line. In this case, two screws 3 are inserted from above through the fastening openings 12 into the countersunk elongated hole 27 and preferably screwed into the latter. This can be carried out in that the elongated hole 27 is somewhat narrower than the outer diameter of the screw thread. Accordingly, screws 3 screw themselves tightly into the elongated hole 27. Alternatively, screws can be tightened by nuts. Or the fastening openings 12 have a thread and the screws 3 are inserted from the bottom through the elongated hole 27 and screwed tightly into the fastening openings 12.

This embodiment allows the aforementioned angle α to be freely selected within limits determined by the elongated hole 27.

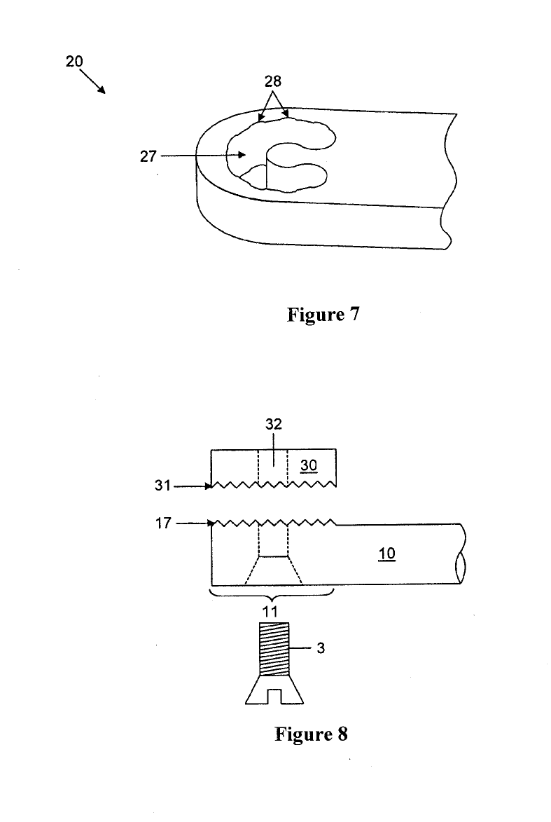

FIG. 7 shows the arm part 20 of FIG. 6 in modified form. This embodiment differs from the foregoing with respect to the shape of the elongated hole 27. The elongated hole 27 has indentations 28 which fix the arm parts 10, 20 relative to one another while the fastening screw(s) 3 are inserted. In other word, the arm parts 10, 20 can only occupy predefined positions relative to one another. The relative position of the arm parts 10, 20 with respect to one another is definitively fixed by tightening, e.g., two screws 3, not shown here.

In the embodiments described above, the elongated hole 27 is preferably formed in such a way that the arm parts 10, 20 can be oriented relative to one another in every possible relative position without having to disconnect the arm parts 10, 20 from one another and reassemble them again. In other words, in order to change the relative position, the screws 3 need only be loosened, the arm parts 10, 20 realigned again with respect to one another, and the screws 3 simply tightened once more.

FIG. 8 shows the arm part 10 of a sliding rail linkage arm 2 according to a fifth embodiment of the invention in conjunction with a driven shaft 30.

The fastening portion 11 has a toothed portion 17, e.g., in the form of a crown gear, at its side facing in direction of the driven shaft 30 of the swing leaf operator 7, which is otherwise not illustrated. Correspondingly, driven shaft 30 has a toothed portion 31 that substantially complements the toothed portion 17. A screw 3 is screwed into a corresponding fastening opening 32 in driven shaft 30 through toothed portion 17 and secures arm part 10 and driven shaft 30 to one another. The two parts 10, 30 are fixed with respect to rotation relative to one another by the mutual engagement of toothed portions 17, 31.

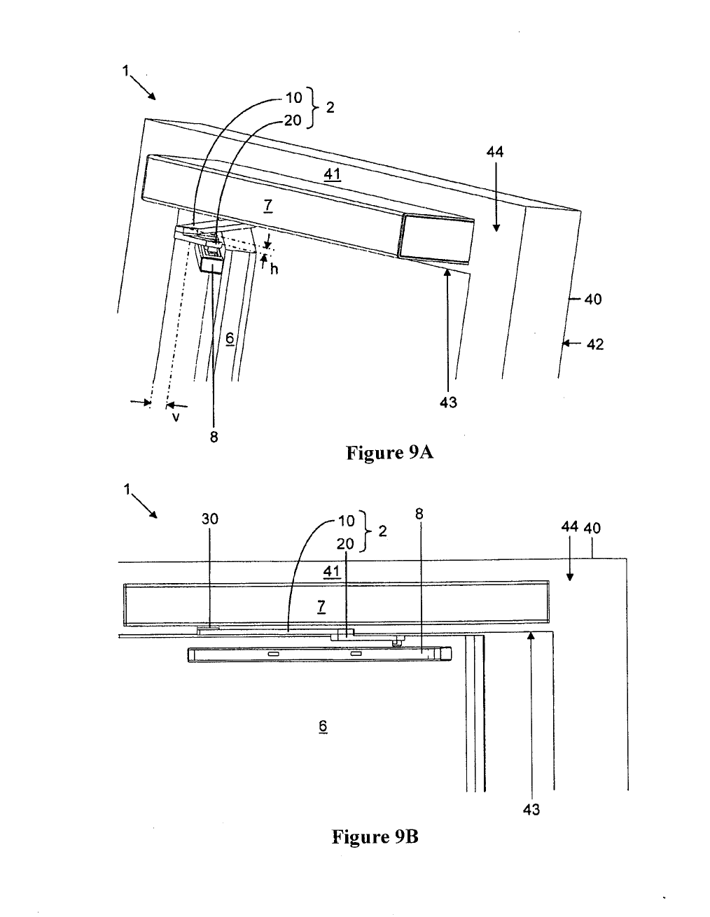

FIG. 9A is a perspective view showing the upper portion of another swing leaf installation 1, which is likewise constructed as a swing door installation. The door leaf 6 is shown in a partially open position.

Leaf 6 is hung in a door frame 40, for example, so as to be substantially flush in the closed position with a concealed back side or back surface 42 of door frame 40, which back surface 42 in this case faces to the rear, and is opened by its opposite side, i.e., in this case toward the front in direction of the visible front side 44 of the door frame 40. The swing leaf operator 7 is arranged on the front side 44 of the upper crossbeam 41 of the door frame 40, i.e., opens the leaf 6 in a “pulling” manner. Accordingly, the sliding rail 8 of the linkage, which in this case, by way of example, is formed according to FIGS. 1 to 3C, is arranged at the above-mentioned opposite side of the leaf 6.

The arm 2 with parts 10, 20 is also shown.

In the closed position, leaf 6 is again at a distance from the surface 44 of frame 40 defined by the front side 44, facing forward in this instance, which distance takes the form of a depth offset v. Accordingly, in the closed position the leaf 6 is offset with respect to frame 40 toward the rear in entry direction on the side 44 of the door frame 40 with the swing leaf operator 7.

Due to the above-described vertical offset h between the arm parts 10, 20, the swing leaf operator 7 need not line up flush with an underside or lower surface 43 of the crossbeam 41 facing in direction of the leaf 6, but may be arranged higher. It need merely be ensured that the arm part 20—with the exception of its end 26, not shown here—is located somewhat below the underside 43 and can accordingly move freely past the crossbeam 41.

If the leaf 6 is closed starting from the position shown in FIG. 9A, the arm part 20—with end 26—moves past the underside 43 of the crossbeam. In every opening position of the leaf 6, end 26 and arm part 10 remain in front of side 44, i.e., cannot move past the frame 40. Arm part 10 is preferably aligned in the closed position of leaf 6 as in swinging door installations without an offset v and advantageously extends substantially parallel to the front side of leaf 6 facing it or to the front side 44 of the frame 40. Therefore, the door drive 1 can generate the same torque curve at the leaf 6 as would be generated with a linear linkage arm in a door installation without the offset v.

FIG. 9B shows the swing door installation 1 in entry direction toward side 44 of the frame 40, i.e., in a front view. The arrangement of arm 2 in relation to the crossbeam 41 and the underside 43 thereof can be seen especially clearly in this diagram. The driven shaft 30 of the door drive 7 can also be discerned.

It can clearly be seen from this diagram that only arm part 20, without end 26, need move past the crossbeam 41, and not arm part 10.

Since arm part 10 is arranged above the leaf 6, the leaf 6 can move freely past the arm part 10. The maximum possible opening angle of leaf 6 is determined by arm part 20. If arm 2 were constructed in linear fashion, leaf 6 could not even be opened by 90° due to its swiveling axis to the left of the driven shaft 30 in FIG. 9B. Even the open position shown in FIG. 9A could not be achieved.

As a result of the above-described angle α between the arm parts 10, 20, the arm 2 and driven shaft 30 of the door drive 7 can be rotated until the arm part 20 contacts the leaf 6. The larger the angle α, the farther the leaf 6 can be opened insofar as permitted by the guide rail 8. Therefore, the length of arm part 10 and angle α in particular allow the maximum opening angle of the leaf 6 to be adapted or adjusted to the respective use conditions.

The invention is not limited to the embodiment forms described above.

Ends 16, 26 can be exchanged with each other as regards their configuration so that, for example, the above-mentioned elongated hole 27 is formed in arm part 10.

The quantity of fastening openings 12, 22, 23 may vary.

The pins 4 in connection with the insertion openings 18, 23 can be used in all of the embodiment forms and can be dispensed with in the first embodiment form.

The ends of the arm parts 10, 20 remote of ends 16, 26 may be formed in any manner so as to be operatively connected to a swing leaf operator driven shaft or to a sliding piece for sliding linkage or to a fastening stop for standard linkage or parallel linkage so that the two-part linkage arm 2 according to the invention can also be used in parallel linkages and standard linkages. In other words, it is possible to vary the external shape and connection to the driven shaft 30 of the swing leaf operator 7 at one end and, at the other end, to a sliding piece, a second linkage arm or to a fastening part, known per se, for articulated connection of the linkage to the swing leaf 6 or a part of the entire swing leaf installation 1 which is stationary with respect to this swing leaf installation 1. What is essential is the variable orientation of the arm parts 10, 20 with respect to one another.

In order to (better) fix the relative position of the arm parts 10, 20 with respect to one another, any type of frictional or positive engagement may be provided between them. It is possible, for example, to provide the arm parts 10, 20 at the opposed, mutually contacting sides of the crown gear toothing shown in FIG. 8

As a result, the invention provides a simple possibility for compensating for an offset v between a swing leaf 6 and a part of the swing leaf installation 1 that is stationary with respect to the swing leaf 6 regardless of the hinging side of the swing leaf 6 with respect to the rest of the installation 1 using one and the same arm 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. An arm (2) forming a linkage arm of a standard linkage or parallel linkage having two linkage arms, or of a sliding rail linkage, the arm (2) comprising:
a first linkage arm part (10); and
a second linkage arm part (20),
wherein:
the first linkage arm part (10) is arranged with one end (11) at a driven shaft (30) of a swing leaf operator (7) so as to be fixed with respect to rotation relative to the driven shaft (30), so that the swing leaf operator (7) can swivel the first linkage arm part (10) around a first end of the first linkage arm part (10), as a center point of a rotational axis (R) of the first linkage arm part (10), the first linkage arm part (10) being configured, at a second end of the first linkage arm part (10), to be arranged at a first end (26) of the second linkage arm part (20), so as to be fixed with respect to rotation relative to the second linkage arm part (20),
a second end of the second linkage arm part (20) is configured to be articulately connected to a part arranged so as to be swivelable with respect to the swing leaf operator (7) such that the swing leaf operator (7) can open and/or close a swing leaf (6) via the driven shaft (30) and the standard linkage, parallel linkage or sliding rail linkage connected thereto, and
both the first and second linkage arm parts (10, 20) are configured, viewed in a direction along the rotational axis (R) of the first linkage arm part (10), to be arranged with respect to one another so as to be fixed with respect to relative rotation such that, viewed in direction along the rotational axis (R) of the first linkage arm part (10), the two linkage arm parts (10, 20) form a first reflex angle (α) at one side (13, 24) in a first mounting condition, and form a second reflex angle (α) at another side (14, 25), opposed to the one side (13, 24), in a second mounting condition.

13. The arm (2) according to claim 12, wherein each linkage arm part (10, 20) has one or more fasteners (2, 3, 12, 21-23) formed such that, in the first mounting condition, the second linkage arm part (10, 20), viewed along the rotational axis (R) of the first linkage arm part (10), is arranged so as to be rotated, by a predetermined angle, with respect to the second mounting condition and/or, viewed along the longitudinal extension of the first linkage arm part (10), is arranged at 180° with respect to the second mounting condition.

14. The arm (2) according to claim 13, wherein the first linkage arm part (10) and/or the second linkage arm part (20) have or has, in association with each instance of the one or more fasteners (2, 3, 12, 21-23), a fastening device (12; 21, 22) formed symmetrically viewed along the longitudinal extension of the first linkage arm part (10) and second linkage arm part (20), respectively.

15. The arm (2) according to claim 14, wherein the fastening device (12; 21, 22) comprises fastening openings (12; 21, 22).

16. The arm (2) according to claim 15, wherein the fastening openings (12; 21, 22) are arranged so as to define the reflex angle (α) between the first and second linkage arm parts (10, 20).

17. The arm (2) according to claim 16, wherein at least some (12; 21, 22) of the fastening openings (12; 21, 22) extend parallel to the rotational axis (R) of the first linkage arm part (10).

18. The arm (2) according to claim 15, wherein at least some (21) of the fastening openings (12; 21, 22) include an inner thread and/or are formed so as to pass completely through the first (10) and/or second (20) linkage arm parts, and are further configured such that a fastener (3, 4) corresponding to a respective fastening opening (12; 21, 22) can be inserted into the respective fastening opening (12; 21, 22) from both sides thereof.

19. The arm (2) according to claim 12, further comprising adjusting devices (27, 28) configured to adjust the reflex angle (α) between the first and second linkage arm parts (10, 20).

20. The arm (2) according to claim 19, wherein the adjusting devices include a catch mechanism (27, 28) formed on at least one of the first and second linkage arm parts (10, 20).

21. A swing leaf operator (7) comprising:
a driven shaft (30) emerging from the swing leaf operator (7) at at least one end of the swing leaf operator (7);
an actuating mechanism operatively coupled to the driven shaft (30) so as to rotate the driven shaft (30) in at least one direction; and
a standard linkage, parallel linkage or sliding rail linkage having an arm (2) according to claim 12,
wherein:
the driven shaft (30) has a fastening portion (32) at the at least one end of the swing leaf operator (7), the fastening portion (32) being arranged at an associated end of the first linkage arm part (10) so as to be fixed with respect to rotation relative to it, and
the second end of the second linkage arm part (20) is articulately connected to a fastening stop as a part that is swivelably arranged with respect to the swing leaf operator (7) in case of a standard arm linkage or parallel arm linkage, and, in case of a sliding rail linkage, the second end of the second linkage arm part (20) is articulately connected to a sliding piece as the part that is swivelably arranged with respect to the swing leaf operator (7), the sliding piece being translationally guided in a sliding rail (8) of the swing leaf operator (7).

22. A swing leaf installation (2) having a swing leaf (6) and a swing leaf operator (7) according to claim 21, wherein the swing leaf operator (7) is arranged at the swing leaf (6) or at a part (5, 41) stationary with respect to the entire swing leaf installation (2), and the part that is swivelably arranged with respect to the swing leaf operator (7) is arranged at the part (5, 41) stationary with respect to the entire swing leaf installation (2) or at the swing leaf (6).
